(19) United States
(12) Patent Application Publication
(10) Pub. No.: US 2024/0415179 A1
(43) Pub. Date: Dec. 19, 2024

(54) AEROSOL GENERATING DEVICE INCLUDING SHOCK ABSORBER

(71) Applicant: KT&G CORPORATION, Daejeon (KR)

(72) Inventors: Dong Sung KIM; Hunil LIM, Seoul (KR); Youngbum KWON, Yongin-si (KR); Yong Hwan KIM, Anyang-si (KR)

(73) Assignee: KT&G CORPORATION, Daejeon (KR)

(21) Appl. No.: 18/567,923

(22) PCT Filed: Jul. 17, 2023
(86) PCT No.: PCT/KR2023/010151

§ 371 Date: Dec. 7, 2023

(30) Foreign Application Priority Data
Aug. 10, 2022 (KR) 10-2022-0099731
Oct. 7, 2022 (KR) 10-2022-0128352

(51) Int. Cl. A24F 40/46; A24F 40/40; A24F 40/51; A24F 40/53

(52) U.S. Cl. CPC A24F 40/46; A24F 40/40; A24F 40/51; A24F 40/53

(57) ABSTRACT

An aerosol generating device includes a housing, a heater configured to heat an aerosol generating article and disposed in a first portion of the housing, a battery configured to supply electrical energy to the heater and disposed in a second portion of the housing, a protective circuit board connected to the battery and disposed in the second portion of the housing such that a clearance space is formed between the protective circuit board and the second portion of the housing, and a shock absorber configured to absorb shock to the protective circuit board and/or the battery and disposed in the clearance space.

### TECHNICAL FIELD

The disclosure relates to an aerosol generating device, for example, to an aerosol generating device including a shock absorber.

### BACKGROUND ART

Techniques for introducing airflows into an aerosol generating article are being developed to provide atomization performance. For example, aerosol generating devices that generate an aerosol from an aerosol generating article in a non-burning manner are being developed. The above description is information the inventor(s) acquired during the course of conceiving the disclosure, or already possessed at the time, and is not necessarily art publicly known before the present application was filed.

### DISCLOSURE OF THE INVENTION

### Technical Goals

An aspect of the disclosure may provide an aerosol generating device that reduces or prevents damage to a battery and/or a protective circuit board caused by an external shock.

### Technical Solutions

According to an embodiment, an aerosol generating device may include a housing, a heater configured to heat an aerosol generating article and disposed in a first portion of the housing, a battery configured to supply electrical energy to the heater and disposed in a second portion of the housing, a protective circuit board connected to the battery, wherein a clearance space is formed between the protective circuit board and the second portion of the housing, and a shock absorber configured to absorb a shock to the protective circuit board and/or the battery and disposed in the clearance space.

In an embodiment, the shock absorber may be configured to reduce heat transferred from the heater to the protective circuit board and/or the battery.

In an embodiment, the shock absorber may include a first base disposed on the second portion of the housing and a second base disposed on the first base. A width of the first base may be greater than a width of the second base in a direction from the heater toward the battery.

In an embodiment, the shock absorber may include a plurality of pores.

In an embodiment, a shape of one of the plurality of pores may be different from a shape of another pore.

In an embodiment, a shape of one of the plurality of pores may be substantially same as a shape of another pore.

In an embodiment, the housing may further include at least one first engagement portion disposed in the second portion, and the shock absorber may include a second engagement portion configured to engage the first engagement portion.

In an embodiment, the second engagement portion may include a groove.

In an embodiment, the second engagement portion may include a first groove extending in a first direction of the shock absorber and a second groove extending in a second direction of the shock absorber, the second direction intersecting with the first direction.

In an embodiment, the first engagement portion may include a protruding rib.

In an embodiment, the first engagement portion may include a first protruding rib extending in a first direction from the heater toward the battery and a second protruding rib extending in a second direction intersecting with the first direction.

In an embodiment, the shock absorber may be disposed to occupy substantially an entirety of the clearance space.

In an embodiment, the housing may include a wall configured to separate the first portion and the second portion, and the shock absorber may be disposed to contact the wall.

In an embodiment, the shock absorber may include an elastic material.

In an embodiment, the shock absorber may be configured to have a first shape in which the shock absorber is not deformed and a second shape in which the shock absorber is deformed and compressed.

### Advantageous Effects of Invention

According to an embodiment, damage to a battery and/or a protective circuit board caused by an external shock may be reduced or prevented. According to an embodiment, heat transferred from a heater to a battery may be reduced. The effects of an aerosol generating device including a shock absorber according to an embodiment may not be limited to the above-mentioned effects, and other unmentioned effects may be clearly understood from the following description by one of ordinary skill in the art.

### BRIEF DESCRIPTION OF DRAWINGS

The foregoing and other aspects, features, and advantages of embodiments in the disclosure will become apparent from the following detailed description with reference to the accompanying drawings.

FIG. 1 is a diagram illustrating an aerosol generating device according to an embodiment.

FIG. 2 is a diagram illustrating an aerosol generating device according to an embodiment.

FIG. 3 is a diagram illustrating an aerosol generating device according to an embodiment.

FIG. 4 is a diagram illustrating an aerosol generating article according to an embodiment.

FIG. 5 is a diagram illustrating an aerosol generating article according to an embodiment.

FIG. 6 is a block diagram of an aerosol generating device according to an embodiment.

FIG. 7 is a front perspective view of an aerosol generating device according to an embodiment.

FIG. 8 is a rear perspective view of an aerosol generating device according to an embodiment.

FIG. 9 is a rear perspective view of an internal structure of an aerosol generating device according to an embodiment.

FIG. 10 is a rear exploded perspective view of an internal structure of an aerosol generating device according to an embodiment.

FIG. 11 is a perspective view of a battery and a protective circuit board according to an embodiment.

FIG. 12 is a perspective view of an aerosol generating device including a shock absorber according to an embodiment.

FIG. 13 is a perspective view of an aerosol generating device including a housing in which a shock absorber is disposed according to an embodiment.

FIG. 14 is a cross-sectional view of an aerosol generating device according to an embodiment.

FIG. 15 is a front perspective view of a shock absorber according to an embodiment.

FIG. 16 is a rear perspective view of a shock absorber according to an embodiment.

### MODE FOR THE INVENTION

The terms used in the embodiments are selected from among common terms that are currently widely used, in consideration of their function in the embodiments of the present disclosure. However, different terms may be used depending on an intention of one of ordinary skill in the art, a precedent, or the advent of new technology. In particular cases, the terms are discretionally selected by the applicant of the disclosure, and the meaning of those terms will be described in detail in the corresponding part of the detailed description. Therefore, the terms used in the disclosure should be defined based on the meanings of the terms and all the content of the disclosure, rather than the terms themselves.

It will be understood that when a certain part “includes” a certain component, the part does not exclude another component but may further include another component, unless the context clearly dictates otherwise. Terms such as “unit,” “module,” etc., as used in the specification may refer to a part for processing at least one function or operation and may be implemented as hardware, software, or a combination of hardware and software.

Hereinbelow, embodiments of the disclosure will be described in detail with reference to the accompanying drawings so that the embodiments may be readily implemented by one of ordinary skill in the technical field to which the disclosure pertains. However, embodiments may be implemented in many different forms, and the present disclosure is not limited to the embodiments described herein.

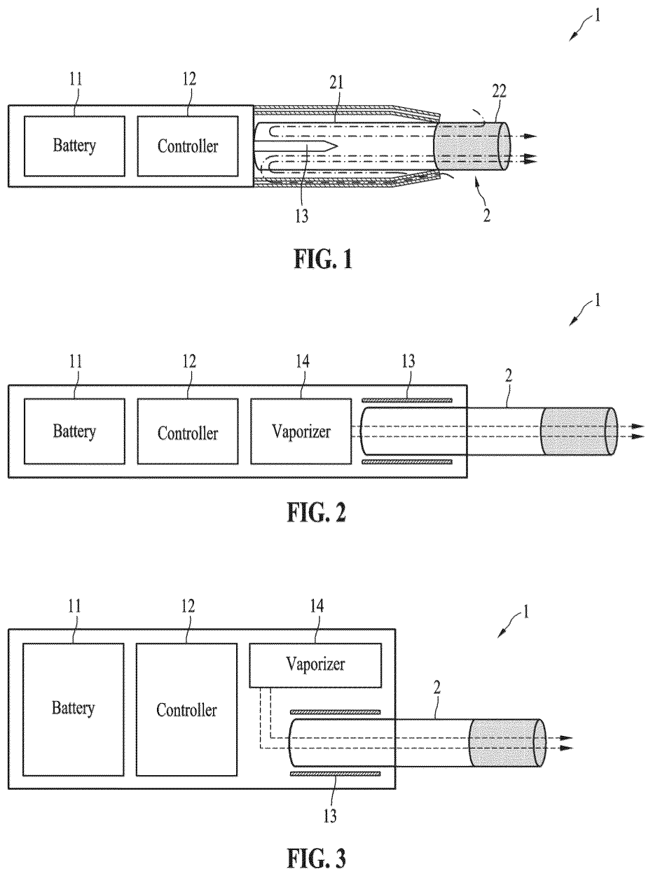

FIG. 1 is a diagram illustrating an aerosol generating device according to an embodiment. FIG. 2 is a diagram illustrating the aerosol generating device according to an embodiment. FIG. 3 is a diagram illustrating the aerosol generating device according to an embodiment.

Referring to FIG. 1, an aerosol generating device 1 may include a battery 11, a controller 12, and a heater 13. Referring to FIGS. 2 and 3, the aerosol generating device 1 may further include a vaporizer 14. An aerosol generating article 2 may be inserted into an inner space of the aerosol generating device 1.

The aerosol generating device 1 shown in FIGS. 1 to 3 may include components related to an embodiment described herein. Therefore, it is to be understood by one of ordinary skill in the art to which the disclosure pertains that the aerosol generating device 1 may further include other general-purpose components in addition to the ones shown in FIGS. 1 to 3.

Although it is shown that the heater 13 is included in the aerosol generating device 1 in FIGS. 2 and 3, the heater 13 may be omitted as needed.

FIG. 1 illustrates a linear alignment of the battery 11, the controller 12, and the heater 13. FIG. 2 illustrates a linear alignment of the battery 11, the controller 12, the vaporizer 14, and the heater 13. FIG. 3 illustrates a parallel alignment of the vaporizer 14 and the heater 13. However, the internal structure of the aerosol generating device 1 is not limited to what is shown in FIGS. 1 to 3. That is, the alignments of the battery 11, the controller 12, the heater 13, and the vaporizer 14 may be changed depending on the design of the aerosol generating device 1.

When the aerosol generating article 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the aerosol generating article 2 into a user.

Even when the aerosol generating article 2 is not inserted into the aerosol generating device 1, the aerosol generating device 1 may heat the heater 13 as needed.

The battery 11 may supply power to be used to operate the aerosol generating device 1. For example, the battery 11 may supply power to heat the heater 13 or the vaporizer 14, and may supply power required for the controller 12 to operate. The battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. The controller 12 may verify a state of each of the components of the aerosol generating device 1 to determine whether the aerosol generating device 1 is in an operable state.

The controller 12 may include at least one processor. The at least one processor may be implemented as an array of a plurality of logic gates, or may be implemented as a combination of a general-purpose microprocessor and a memory in which a program executable by the microprocessor is stored. It is to be understood by one of ordinary skill in the art to which the disclosure pertains that the at least one processor may be implemented in other types of hardware.

The heater 13 may be heated by the power supplied by the battery 11. For example, when an aerosol generating article is inserted into the aerosol generating device 1, the heater 13 may be disposed outside the aerosol generating article. The heated heater 13 may thus raise the temperature of an aerosol generating material in the aerosol generating article.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

The heater 13 may be an induction heater. Specifically, the heater 13 may include an electrically conductive coil for heating the aerosol generating article in an induction heating manner, and the aerosol generating article may include a susceptor to be heated by the induction heater.

For example, the heater 13 may include a tubular heating element, a plate-shaped heating element, a needle-shaped heating element, or a rod-shaped heating element, and may heat the inside or outside of the aerosol generating article 2 according to the shape of a heating element.

The heater 13 may be provided as a plurality of heaters in the aerosol generating device 1. In this case, the plurality of heaters 13 may be disposed to be inserted into the aerosol generating article 2 or may be disposed outside the aerosol generating article 2. Some of the plurality of heaters 13 may be disposed to be inserted into the aerosol generating article 2, and the rest may be disposed outside the aerosol generating article 2. The shape of the heater 13 is not limited to what is shown in FIGS. 1 to 3 but may be provided in various shapes.

The vaporizer 14 may heat a liquid composition to generate an aerosol, and the generated aerosol may pass through the aerosol generating article 2 into the user. That is, the aerosol generated by the vaporizer 14 may travel along an airflow path of the aerosol generating device 1, and the airflow path may be configured such that the aerosol generated by the vaporizer 14 may pass through the aerosol generating article into the user.

For example, the vaporizer 14 may include a liquid storage, a liquid transfer means, and a heating element. However, embodiments are not limited thereto. For example, the liquid storage, the liquid transfer means, and the heating element may be included as independent modules in the aerosol generating device 1.

The liquid storage may store the liquid composition. For example, the liquid composition may be a liquid including a tobacco-containing material having a volatile tobacco flavor component, or may be a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit-flavored ingredients, and the like. However, embodiments are not limited thereto. The flavoring agent may include ingredients that provide a user with a variety of flavors or scents. The vitamin mixture may be a mixture of at least one of vitamin A, vitamin B, vitamin C, or vitamin E. However, embodiments are not limited thereto. The liquid composition may include an aerosol former such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic. However, embodiments are not limited thereto.

The heating element may be an element for heating the liquid composition transferred by the liquid transfer means. The heating element may be, for example, a metal heating wire, a metal heating plate, a ceramic heater, or the like. However, embodiments are not limited thereto. The heating element may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer. However, embodiments are not limited thereto.

The aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. The aerosol generating device 1 may include at least one sensor (e.g., a puff sensor, a temperature sensor, an aerosol generating article insertion detection sensor, etc.). The aerosol generating device 1 may be manufactured to have a structure allowing external air to be introduced or internal gas to flow out even while the aerosol generating article 2 is inserted.

Although not shown in FIGS. 1 to 3, the aerosol generating device 1 may constitute a system along with a separate cradle. For example, the cradle may be used to charge the battery 11 of the aerosol generating device 1. The cradle may be used to heat the heater 13, with the cradle and the aerosol generating device 1 coupled.

The aerosol generating article 2 may be similar to a conventional combustible cigarette. For example, the aerosol generating article 2 may be divided into a first portion including an aerosol generating material and a second portion including a filter or the like. The second portion of the aerosol generating article 2 may also include the aerosol generating material. For example, the aerosol generating material provided in the form of granules or capsules may be inserted into the second portion.

The first portion may be entirely inserted into the aerosol generating device 1, and the second portion may be exposed outside. Only the first portion may be partially inserted into the aerosol generating device 1, or the first portion may be entirely inserted into the aerosol generating device 1 and the second portion may be partially inserted into the aerosol generating device 1. The user may inhale the aerosol while holding the second portion in a mouth of the user. In this case, the aerosol may be generated as external air passes through the first portion, and the generated aerosol may pass through the second portion into the mouth of the user.

For example, the external air may be introduced through at least one air path formed in the aerosol generating device 1. In this example, opening or closing and/or the size of the air path formed in the aerosol generating device 1 may be adjusted by the user. Accordingly, an amount of atomization, a sense of smoking, or the like may be adjusted by the user. The external air may be introduced into the inside of the aerosol generating article 2 through at least one hole formed on a surface of the aerosol generating article 2.

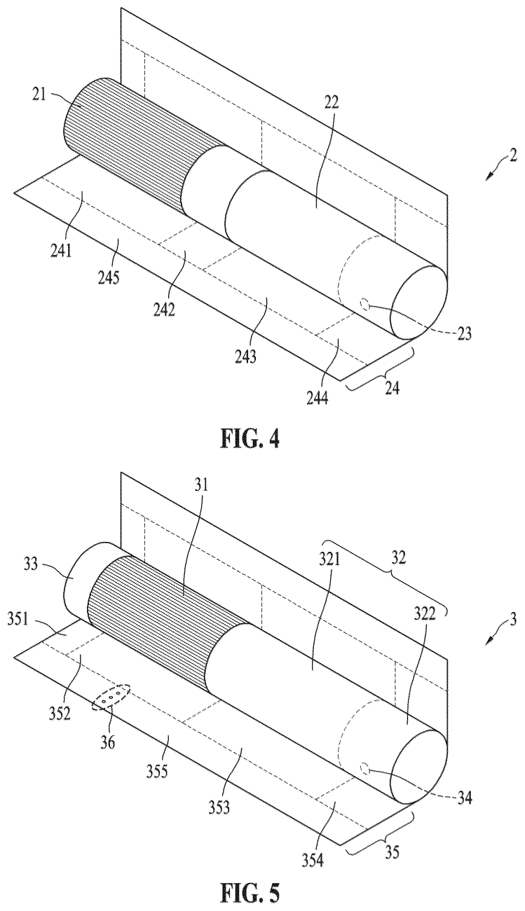

FIG. 4 is a diagram illustrating an aerosol generating article according to an embodiment.

Referring to FIG. 4, the aerosol generating article 2 may include a tobacco rod 21 and a filter rod 22. The first portion and the second portion described above with reference to FIGS. 1 to 3 may include the tobacco rod 21 and the filter rod 22, respectively.

Although the filter rod 22 is illustrated as having a single segment in FIG. 4, embodiments are not limited thereto. That is, the filter rod 22 may include a plurality of segments. For example, the filter rod 22 may include a segment that cools an aerosol and a segment that filters a predetermined ingredient contained in an aerosol. The filter rod 22 may further include at least one segment that performs another function.

A diameter of the aerosol generating article 2 may be in a range of 5 millimeters (mm) to 9 mm, and a length thereof may be about 48 mm. However, embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm. However, embodiments are not limited thereto.

The aerosol generating article 2 may be wrapped with at least one wrapper 24. The wrapper 24 may have at least one hole through which external air is introduced or internal gas flows out. As an example, the aerosol generating article 2 may be wrapped with one wrapper 24. As another example, the aerosol generating article 2 may be wrapped with two or more of wrappers 24 in an overlapping manner. For example, the tobacco rod 21 may be wrapped with a first wrapper 241, and the filter rod 22 may be wrapped with wrappers 242, 243, and 244. In addition, the aerosol generating article 2 may be entirely wrapped again with a single wrapper 245. When the filter rod 22 includes a plurality of segments, the plurality of segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. The first wrapper 241 and the second wrapper 242 may be formed of oilproof paper and/or an aluminum laminated wrapping material.

The third wrapper 243 may be formed of hard wrapping paper. For example, a basis weight of the third wrapper 243 may be in a range of 88 grams per square meter (g/m²) to 96 g/m², and desirably, may be in a range of 90 g/m² to 94 g/m². A thickness of the third wrapper 243 may be in a range of 120 micrometers (μm) to 130 μm, and desirably, may be about 125 μm.

The fourth wrapper 244 may be formed of oilproof hard wrapping paper. For example, a basis weight of the fourth wrapper 244 may be in a range of 88 g/m² to 96 g/m², and desirably, may be in a range of 90 g/m² to 94 g/m². A thickness of the fourth wrapper 244 may be in a range of 120 μm to 130 μm, and desirably, may be about 125 μm.

The fifth wrapper 245 may be formed of sterile paper (e.g., MFW). Here, the sterile paper (MFW) may refer to paper specially prepared such that it has enhanced tensile strength, water resistance, smoothness, or the like, compared to general paper. For example, a basis weight of the fifth wrapper 245 may be in a range of 57 g/m² to 63 g/m², and desirably, may be 60 g/m². A thickness of the fifth wrapper 245 may be in a range of 64 μm to 70 μm, and desirably, may be about 67 μm.

The fifth wrapper 245 may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 245 without limitation.

The fifth wrapper 245 may prevent the aerosol generating article 2 from burning. For example, there may be a probability that the aerosol generating article 2 burns when the tobacco rod 21 is heated by the heater 13. Specifically, when the temperature rises above the ignition point of any one of the materials included in the tobacco rod 21, the aerosol generating article 2 may burn. Even in this case, it may still be possible to prevent the aerosol generating article 2 from burning because the fifth wrapper 245 includes a non-combustible material.

The fifth wrapper 245 may prevent the aerosol generating device 1 from being contaminated by substances produced in the aerosol generating article 2. Liquid substances may be produced in the aerosol generating article 2 when a user puffs. For example, as an aerosol generated in the aerosol generating article 2 is cooled by external air, such liquid substances (e.g., moisture, etc.) may be produced. As the aerosol generating article 2 is wrapped with the fifth wrapper 245, the liquid substances generated within the aerosol generating article 2 may be prevented from leaking out of the aerosol generating article 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may include other additives, such as, for example, a flavoring agent, a wetting agent, and/or an organic acid. The tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be formed as a sheet or a strand. The tobacco rod 21 may also be formed of tobacco leaves finely cut from a tobacco sheet. The tobacco rod 21 may be enveloped by a heat-conductive material. The thermally conductive material may be, for example, metal foil such as aluminum foil. However, embodiments are not limited thereto. For example, the heat-conductive material enveloping the tobacco rod 21 may evenly distribute the heat transferred to the tobacco rod 21 to improve the thermal conductivity to be applied to the tobacco rod 21, thereby improving the taste of tobacco. The thermally conductive material enveloping the tobacco rod 21 may function as a susceptor heated by an induction heater. In this case, although not shown, the tobacco rod 21 may further include an additional susceptor in addition to the thermally conductive material enveloping the outside thereof.

The filter rod 22 may be a cellulose acetate filter. However, a shape of the filter rod 22 is not limited. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

The first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of 2 mm to 4.5 mm. However, embodiments are not limited thereto.

A desirable length of the first segment may be adopted from a range of 4 mm to 30 mm. However, embodiments are not limited thereto. Desirably, the length of the first segment may be 10 mm. However, embodiments are not limited thereto.

The first segment may have a hardness that is adjustable through an adjustment of the content of a plasticizer in the process of manufacturing the first segment. The first segment may be manufactured by inserting a structure such as a film or a tube of the same or different materials therein (e.g., in the hollow).

The second segment of the filter rod 22 may cool an aerosol generated as the heater 13 heats the tobacco rod 21. The user may thus inhale the aerosol cooled down to a suitable temperature.

A length or diameter of the second segment may be determined in various ways according to the shape of the aerosol generating article 2. For example, a desirable length of the second segment may be adopted from a range of 7 mm to 20 mm. Desirably, the length of the second segment may be about 14 mm. However, embodiments are not limited thereto.

The second segment may be manufactured by weaving a polymer fiber. In this case, a flavoring liquid may be applied to a fiber formed of a polymer. The second segment may be manufactured by weaving a separate fiber to which a flavoring liquid is applied and the fiber formed of the polymer together. The second segment may be formed with a crimped polymer sheet.

The polymer may be prepared with a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed with the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment formed with the crimped polymer sheet may be formed of a material having a thickness between about 5 μm and about 300 μm, for example, between about 10 μm and about 250 μm. A total surface area of the second segment may be between about 300 square millimeters per millimeter (mm²/mm) and about 1000 mm²/mm. An aerosol cooling element may be formed from a material having a specific surface area between about 10 square millimeters per milligram (mm²/mg) and about 100 mm²/mg.

Meanwhile, the second segment may include a thread containing a volatile flavor ingredient. The volatile flavor ingredient may be menthol. However, embodiments are not limited thereto. For example, the thread may be filled with an amount of menthol sufficient to provide at least 1.5 mg of menthol to the second segment.

The third segment of the filter rod 22 may be a cellulose acetate filter. A desirable length of the third segment may be adopted from a range of 4 mm to 20 mm. For example, the length of the third segment may be about 12 mm. However, embodiments are not limited thereto.

The third segment may be manufactured such that a flavor is generated by spraying a flavoring liquid onto the third segment in the process of manufacturing the third segment. A separate fiber to which the flavoring liquid is applied may be inserted into the third segment. An aerosol generated in the tobacco rod 21 may be cooled as it passes through the second segment of the filter rod 22, and the cooled aerosol may pass through the third segment into the user. Accordingly, when a flavoring element is added to the third segment, the flavor carried to the user may last much longer.

The filter rod 22 may include at least one capsule 23. The capsule 23 may perform a function of generating a flavor, or a function of generating an aerosol. For example, the capsule 23 may have a structure in which a liquid containing a fragrance is wrapped with a film. The capsule 23 may have a spherical or cylindrical shape. However, embodiments are not limited thereto.

FIG. 5 is a diagram illustrating an aerosol generating article according to an embodiment.

Referring to FIG. 5, an aerosol generating article 3 may further include a front end plug 33. The front end plug 33 may be disposed on one side of a tobacco rod 31 facing a filter rod 32. The front end plug 33 may prevent the tobacco rod 31 from escaping to the outside, and may also prevent an aerosol liquefied in the tobacco rod 31 during smoking from flowing into an aerosol generating device (e.g., the aerosol generating device 1 of FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

A diameter and a total length of the aerosol generating article 3 may correspond to the diameter and the total length of the aerosol generating article 2 of FIG. 4. For example, the length of the front end plug 33 may be about 7 mm, the length of the tobacco rod 31 may be about 15 mm, the length of the first segment 321 may be about 12 mm, and the length of the second segment 322 may be about 14 mm. However, embodiments are not limited thereto.

The aerosol generating article 3 may be wrapped by at least one wrapper 35. The wrapper 35 may have at least one hole through which external air is introduced or internal gas flows out. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the aerosol generating article 3 may be entirely wrapped again with a fifth wrapper 355.

At least one perforation 36 may be formed in the fifth wrapper 355. For example, the perforation 36 may be formed in an area surrounding the tobacco rod 31. However, embodiments are not limited thereto. The perforation 36 may perform a function of transferring heat generated by the heater 13 shown in FIGS. 2 and 3 to the inside of the tobacco rod 31.

The second segment 322 may include at least one capsule 34. The capsule 34 may perform a function of generating a flavor or a function of generating an aerosol. For example, the capsule 34 may have a structure in which a liquid containing a fragrance is wrapped with a film. The capsule 34 may have a spherical or cylindrical shape. However, embodiments are not limited thereto.

The first wrapper 351 may be a combination of general filter wrapping paper and metal foil such as aluminum foil. For example, a total thickness of the first wrapper 351 may be in a range of 45 μm to 55 μm, and desirably, may be about 50.3 μm. A thickness of the metal foil of the first wrapper 351 may be in a range of 6 μm to 7 μm, and desirably, may be 6.3 μm. A basis weight of the first wrapper 351 may be in a range of 50 g/m² to 55 g/m², and desirably, may be 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto. A thickness of the second wrapper 352 may be in a range of 70 μm to 80 μm, and desirably, may be 78 μm. A basis weight of the second wrapper 352 may be in a range of 20 g/m² to 25 g/m², and desirably, may be 23.5 g/m².

For example, the porosity of the third wrapper 353 may be 24000 CU. However, embodiments are not limited thereto. A thickness of the third wrapper 353 may be in a range of 60 μm to 70 μm, and desirably, may be 68 μm. A basis weight of the third wrapper 353 may be in a range of 20 g/m² to 25 g/m², and desirably, may be 21 g/m².

The fourth wrapper 354 may be formed with polylactic acid (PLA) laminated paper. Here, the PLA laminated paper may refer to three-ply paper including a paper layer, a PLA layer, and a paper layer. For example, a thickness of the fourth wrapper 354 may be in a range of 100μm to 120 μm, and desirably, may be 110 μm. A basis weight of the fourth wrapper 354 may be in a range of 80 g/m² to 100 g/m², and desirably, may be 88 g/m².

The fifth wrapper 355 may be formed of sterile paper (e.g., MFW). Here, the sterile paper (MFW) may refer to paper specially prepared such that it has enhanced tensile strength, water resistance, smoothness, or the like, compared to general paper. For example, a basis weight of the fifth wrapper 355 may be in a range of 57 g/m² to 63 g/m², and desirably, may be 60 g/m².

A thickness of the fifth wrapper 355 may be in a range of 64 μm to 70 μm, and desirably, may be 67 μm.

The fifth wrapper 355 may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. A mono denier of a filament of the cellulose acetate tow may be in a range of 1.0 to 10.0, and desirably, may be in a range of 4.0 to 6.0. A mono denier of a filament of the front end plug 33 may be more desirably 5.0. A cross section of the filament constituting the front end plug 33 may be Y-shaped. A total denier of the front end plug 33 may be in a range of 20000 to 30000, and desirably, may be in a range of 25000 to 30000. The total denier of the front end plug 33 may be more desirably 28000.

The front end plug 33 may include at least one channel. The cross-sectional shape of the channel may be manufactured in various manners.

The tobacco rod 31 may correspond to the tobacco rod 21 described above with reference to FIG. 4. Thus, a detailed description of the tobacco rod 31 will be omitted here.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, a mono denier and a total denier of the first segment 321 may be the same as the mono denier and the total denier of the front end plug 33.

The second segment 322 may be formed of cellulose acetate. A mono denier of a filament of the second segment 322 may be in a range of 1.0 to 10.0, and desirably, may be in a range of 8.0 to 10.0. The mono denier of the filament of the second segment 322 may be more desirably 9.0. A cross section of the filament of the second segment 322 may be Y-shaped. A total denier of the second segment 322 may be in a range of 20000 to 30000, and desirably, may be 25000.

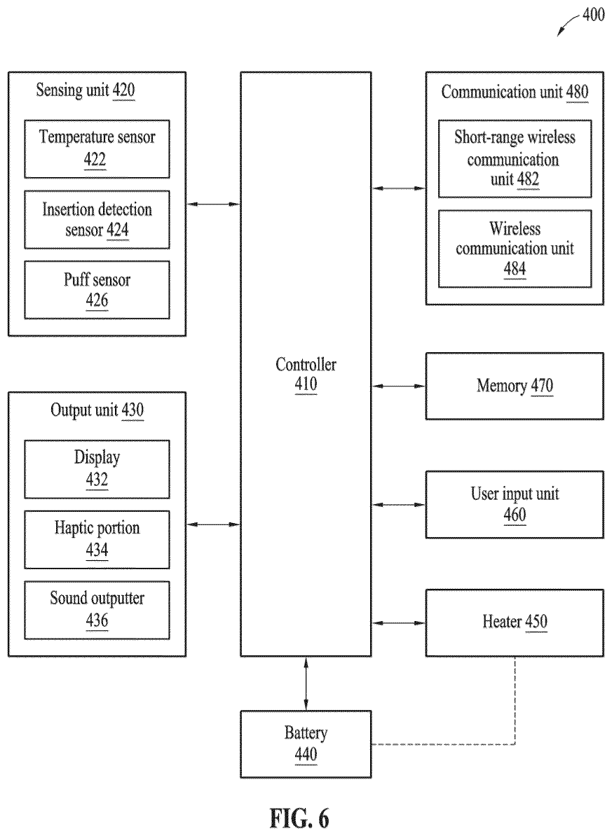

FIG. 6 is a block diagram of an aerosol generating device according to an embodiment.

Referring to FIG. 6, an aerosol generating device 400 may include a controller 410, a sensing unit 420, an output unit 430, a battery 440, a heater 450, a user input unit 460, a memory 470, and a communication unit 480. However, the internal structure of the aerosol generating device 400 is not limited to what is shown in FIG. 6. It is to be understood by one of ordinary skill in the art to which the disclosure pertains that some of the components shown in FIG. 6 may be omitted or new components may be added according to the design of the aerosol generating device 400.

The sensing unit 420 may sense a state of the aerosol generating device 400 or a state of an environment around the aerosol generating device 400, and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted, display a notification, and perform other functions.

The sensing unit 420 may include at least one of a temperature sensor 422, an insertion detection sensor 424, or a puff sensor 426. However, embodiments are not limited thereto.

The temperature sensor 422 may sense a temperature at which the heater 450 (or an aerosol generating material) is heated. The aerosol generating device 400 may include a separate temperature sensor for sensing the temperature of the heater 450, or the heater 450 itself may perform a function as a temperature sensor. The temperature sensor 422 may be arranged around the battery 440 to monitor the temperature of the battery 440.

The insertion detection sensor 424 may sense whether the aerosol generating article is inserted or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 426 may sense a puff from a user based on various physical changes in an airflow path or airflow channel. For example, the puff sensor 426 may sense the puff from the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 422 to 426 described above. A function of each sensor may be intuitively inferable from its name by one of ordinary skill in the art, and thus, a detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display (LCD) panel, an organic light-emitting display (OLED) panel, or the like. The display 432 may be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. The battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 6, the aerosol generating device 400 may further include a power conversion circuit (e.g., a direct current (DC)-to-DC (DC/DC) converter) that converts power of the battery 440 and supplies the power to the heater 450. When the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 6, the aerosol generating device 400 may further include a power conversion circuit, for example, a low dropout (LDO) circuit or a voltage regulator circuit, which converts the power of the battery 440 and supplies the power to respective components.

In an embodiment, the heater 450 may be formed of a predetermined electrically resistive material that is suitable. For example, the electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. The heater 450 may be implemented as a metal heating wire, a metal heating plate on which an electrically conductive track is arranged, a ceramic heating element, or the like. However, embodiments are not limited thereto.

In an embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating an aerosol generating article and a second heater for heating a liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. Although not shown in FIG. 6, the aerosol generating device 400 may further include a connection interface such as a universal serial bus (USB) interface, and may be connected to another external device through the connection interface such as a USB interface to transmit and receive information or to charge the battery 440.

The memory 470, which is hardware for storing various pieces of data processed in the aerosol generating device 400, may store data processed by the controller 410 and data to be processed by the controller 410. The memory 470 may include at least one type of storage medium of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile, data associated with a smoking pattern of the user, or the like.

The communication unit 480 may include at least one component for communicating with another electronic device. For example, the communication unit 480 may include a short-range wireless communication unit 482 and a wireless communication unit 484.

The short-range wireless communication unit 482 may include a Bluetooth communication unit, a Bluetooth low energy (BLE) communication unit, a near field communication unit, a wireless local area network (WLAN) (wireless fidelity (Wi-Fi)) communication unit, a ZigBee communication unit, an infrared data association (IrDA) communication unit, a Wi-Fi direct (WFD) communication unit, an ultra-wideband (UWB) communication unit, and an Ant+communication unit. However, embodiments are not limited thereto.

The wireless communication unit 484 may include, for example, a cellular network communication unit, an Internet communication unit, a computer network (e.g., a LAN or a wide-area network (WAN)) communication unit, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The at least one processor may be implemented as an array of a plurality of logic gates, or may be implemented as a combination of a general-purpose microprocessor and a memory in which a program executable by the microprocessor is stored. It is to be understood by one of ordinary skill in the art to which the present disclosure pertains that it may be implemented in other types of hardware.

The controller 410 may control the temperature of the heater 450 by controlling the supply of power from the battery 440 to the heater 450. For example, the controller 410 may control the supply of power by controlling switching of a switching element between the battery 440 and the heater 450. As another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. As another example, the controller 410 may control an amount of power to be supplied to the heater 450 and a time for which the power is to be supplied, such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when the number of puffs counted through the puff sensor 426 reaches a preset number, the controller 410 may inform the user that the aerosol generating device 400 is to be ended soon, through at least one of the display 432, the haptic portion 434, or the sound outputter 436.

In an embodiment, the controller 410 may control a power supply time and/or a power supply amount for the heater 450 according to a state of the aerosol generating article sensed by the sensing unit 420. For example, when the aerosol generating article is in an over-humidified state, the controller 410 may control the power supply time for an inductive coil to increase a preheating time, compared to a case where the aerosol generating article is in a general state.

An embodiment may be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. The computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms and includes any information transfer medium.

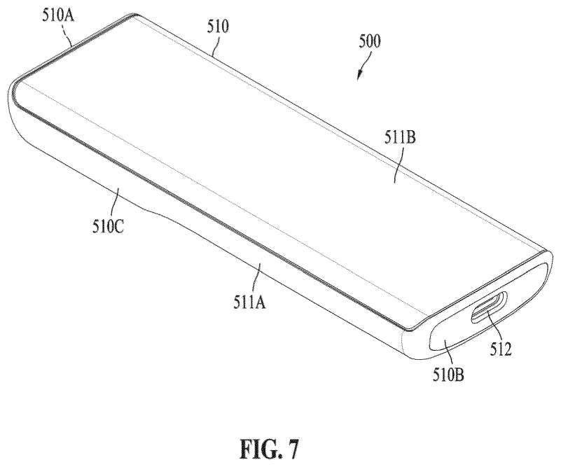

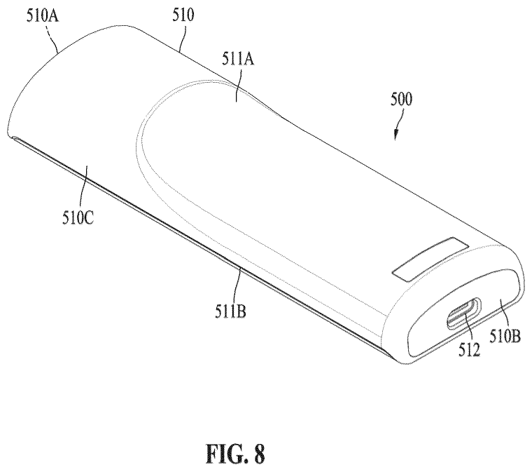

FIG. 7 is a front perspective view of an aerosol generating device according to an embodiment. FIG. 8 is a rear perspective view of the aerosol generating device according to an embodiment.

Referring to FIGS. 7 and 8, an aerosol generating device 500 may include a housing 510. The housing 510 may include a first housing surface 510A (e.g., a housing front surface), a second housing surface 510B (e.g., a housing rear surface) opposite to the first housing surface 510A, and at least one housing side surface 510C between the first housing surface 510A and the second housing surface 510B.

In an embodiment, the housing 510 may include a plurality of housing parts. For example, the housing 510 may include a first housing part 511A and a second housing part 511B. The first housing part 511A may substantially form the first housing surface 510A and the second housing surface 510B. The first housing part 511A may form at least a partial area of the side housing surface 510C, and the second housing part 511B may form the remaining area of the side housing surface 510C. In an embodiment, the first housing part 511A may be detachably coupled to the second housing part 511B.

In an embodiment, the housing 510 may include an insertion opening (not shown) configured to allow an aerosol generating article (not shown) to be inserted therein. The insertion opening may be disposed in the first housing surface 510A.

In an embodiment, the housing 510 may include a connecting terminal 512. The connecting terminal 512 may include a connector via which the aerosol generating device 500 may be physically connected to an external electronic device. For example, the connecting terminal 512 may include, for example, at least one of a high-definition multimedia interface (HDMI) connector, a USB connector, a secure digital (SD) card connector, or an audio connector (e.g., a headphone connector), or a combination thereof.

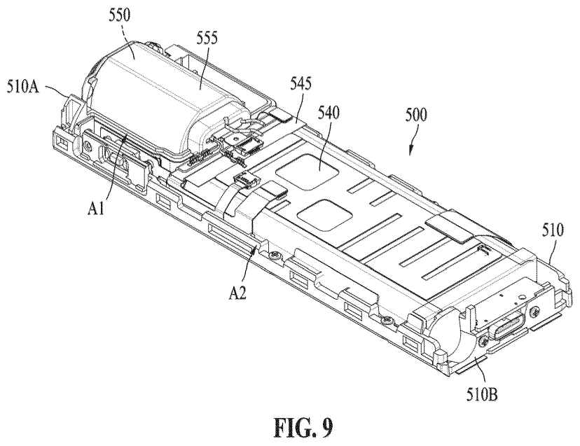

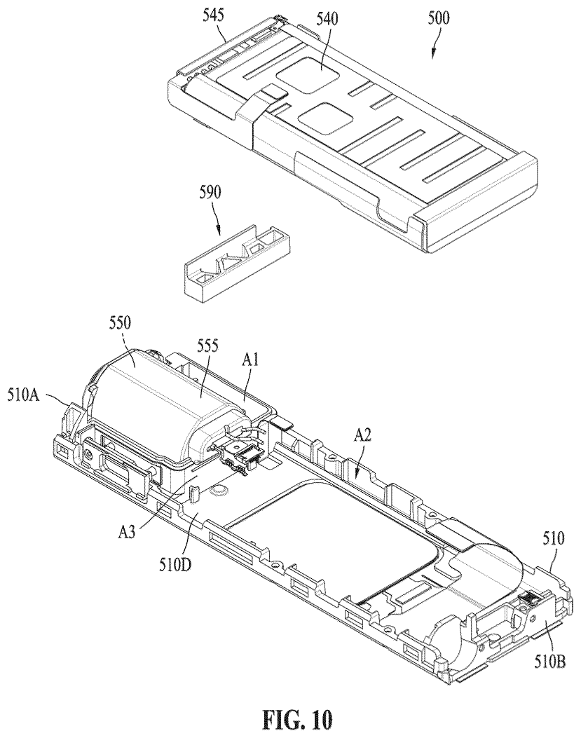

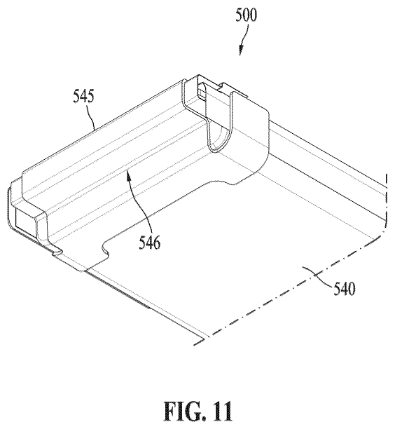

FIG. 9 is a rear perspective view of an internal structure of an aerosol generating device according to an embodiment. FIG. 10 is a rear exploded perspective view of the internal structure of the aerosol generating device according to an embodiment. FIG. 11 is a perspective view of a battery and a protective circuit board according to an embodiment.

Referring to FIGS. 9 to 11, the aerosol generating device 500 may include the housing 510. The housing 510 may include a first portion A1. The first portion A1 may include a portion adjacent to the first housing surface 510A of the housing 510. The housing 510 may include a second portion A2. The second portion A2 may be at least partially different from the first portion A1. The second portion A2 may include a portion adjacent to the second housing surface 510B of the housing.

In an embodiment, the housing 510 may include a wall A3. The wall A3 may be configured to separate the first portion A1 and the second portion A2. The wall A3 may extend from an inner surface 510D of the housing 510 in a normal direction of the inner surface 510D. The wall A3 may extend across the inner surface 510D in a direction (e.g., a width direction of the housing 510) that intersects with a normal direction (e.g., a thickness direction of the housing 510) of the inner surface 510D of the housing 510. The extending direction of the wall A3 may intersect with (e.g., be orthogonal to) a direction (e.g., a longitudinal direction of the housing 510) from the first housing surface 510A toward the second housing surface 510B of the housing 510.

In an embodiment, the aerosol generating device 500 may include a battery 540. For example, the battery 540 may include a pouch-type battery. The battery 540 may be disposed in the second portion A2 of the housing 510.

In an embodiment, the aerosol generating device 500 may include a protective circuit board 545. The protective circuit board 545 may reduce or prevent a risk of the battery 540 exploding and/or being damaged when the battery 540 is in an abnormal state (e.g., thermal runaway). The protective circuit board 545 may enclose the battery 540. The protective circuit board 545 may be disposed on the battery 540 to fit a shape (e.g., a stepped shape) of the battery 540. An arrangement structure of the protective circuit board 545 may form an empty space 546. When the battery 540 is disposed in the battery 510 and an external shock is applied to the housing 510, the battery 540 and/or the protective circuit board 545 may be damaged because of the empty space 546.

In an embodiment, the aerosol generating device 500 may include a heater 550. The heater 550 may be disposed in the first portion A1 of the housing 510.

In an embodiment, the aerosol generating device 500 may include a thermal insulator 555. The thermal insulator 555 may be configured to thermally insulate the heater 550. The thermal insulator 555 may be disposed in the first portion A1 of the housing 510. The thermal insulator 555 may enclose the heater 550.

In an embodiment, the aerosol generating device 500 may include a shock absorber 590. The shock absorber 590 may be configured to absorb a shock to the battery 540 and/or the protective circuit board 545. The shock absorber 590 may be disposed in the empty space 546 between the inner surface 510D of the second portion A2 of the housing 510 and the protective circuit board 545. The shock absorber 590 may be configured to reduce or prevent a shock applied to the battery 540 and the protective circuit board 545, for example, when an external shock (e.g., vibration) is applied to the aerosol generating device 500.

In an embodiment, the shock absorber 590 may be configured to be elastically deformed. For example, the shock absorber 590 may transition between a first shape (e.g., an initial shape) in which the shock absorber is not deformed and a second shape (e.g., a compressed shape) in which the shock absorber is deformed and compressed.

In an embodiment, the shock absorber 590 may be compressed to about 95% or less, 90% or less, 85% or less, 80% or less, 75% or less, 70% or less, 60% or less, or 50% or less of the initial shape.

In an embodiment, the shock absorber 590 may be gently compressed. For example, the shock absorber 590 may be compressed until just before reaching a permanent deformation state according to a predetermined elastic profile. The elastic profile of the shock absorber 590 may be determined based on an elasticity coefficient of a material that forms the shock absorber 590.

In an embodiment, the shock absorber 590 may include an elastic material. For example, the shock absorber 590 may include at least one of silicone, a thermoplastic polyurethane (TPU), a thermoplastic elastomer (TPE), or a rubber, or a combination thereof.

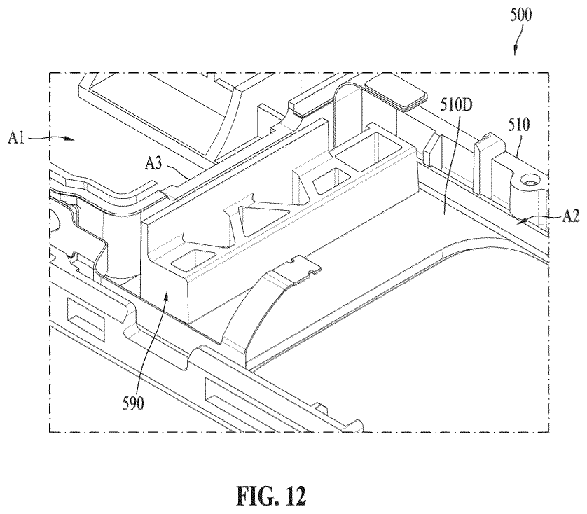

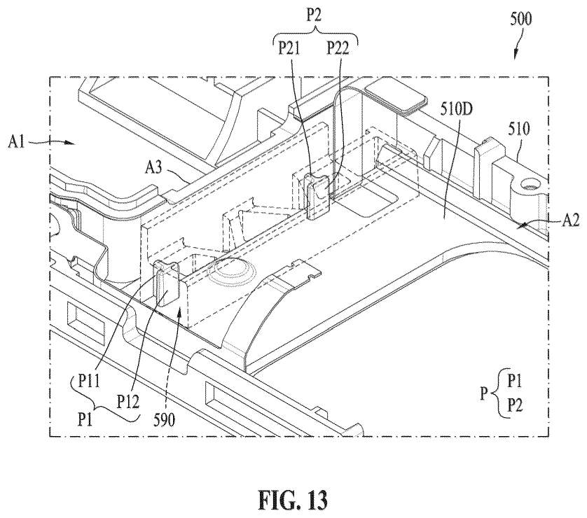

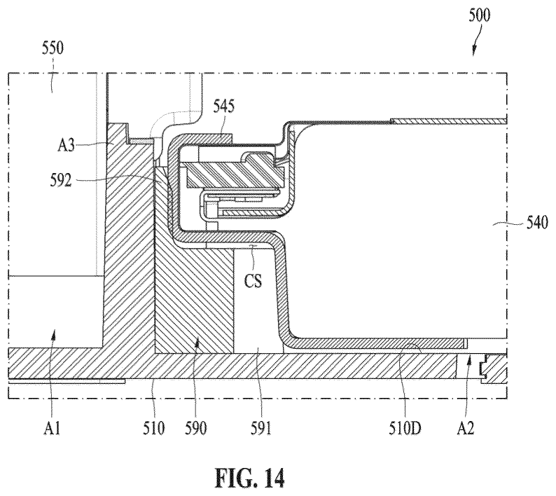

FIG. 12 is a perspective view of an aerosol generating device including a shock absorber according to an embodiment. FIG. 13 is a perspective view of an aerosol generating device including a housing in which a shock absorber is disposed according to an embodiment. FIG. 14 is a cross-sectional view of an aerosol generating device according to an embodiment.

Referring to FIGS. 12 to 14, the aerosol generating device 500 may include the shock absorber 590. The shock absorber 590 may be disposed where the second portion A2 and the wall A3 of the housing 510 meet. The shock absorber 590 may be configured to reduce thermal energy transferred from the heater 550 disposed in the first portion A1 of the housing 510 to the battery 550 disposed in the second portion A2 of the housing 510. The shock absorber 590 may be configured to thermally insulate the heater 550.

In an embodiment, the shock absorber 590 may be disposed in a clearance space CS (e.g., the empty space 546 of FIG. 11). The clearance space CS may be defined as a space between the protective circuit board 545 and the wall A3 and/or a space between the protective circuit board 545 and the inner surface 540D of the housing 510. The shock absorber 590 may occupy substantially an entirety of the clearance space CS.

In an embodiment, the shock absorber 590 may be disposed in the second portion A2 of the housing 510. The shock absorber 590 may be disposed on the inner surface 510D of the second portion A2. The shock absorber 590 may contact the inner surface 510D. The shock absorber 590 may reduce a displacement of the battery 540 and/or the protective circuit board 545 towards the inner surface 510D.

In an embodiment, the shock absorber 590 may contact the wall A3. The shock absorber 590 may reduce the displacement of the battery 540 and/or the protective circuit board 545 towards the wall A3.

In an embodiment, the shock absorber 590 may be configured to engage with the housing 510. When the shock absorber 590 engages with the housing 510, the shock absorber 590 may exhibit robustness.

In an embodiment, the housing 510 may include a first engagement portion P. The first engagement portion P may be configured to engage with the shock absorber 590.

In an embodiment, the first engagement portion P may include a first protrusion P1. The first protrusion P1 may protrude from the wall A3 toward the second portion A2. The first protrusion P1 may be disposed on the inner surface 510D.

In an embodiment, the first protrusion P1 may include a first protruding rib P11. The first protruding rib P11 may protrude in a longitudinal direction of the housing 510 (i.e., in a direction from the heater 550 disposed in the first portion A1 toward the battery 540 disposed in the second portion A2).

In an embodiment, the first protrusion P1 may include a second protruding rib P12. The second protruding rib P12 may protrude from the first protruding rib P11 in a direction that intersects with (e.g., is orthogonal to) the protruding direction of the first protruding rib P11. The second protruding rib P12 may extend in a width direction of the housing 510. The second protruding rib P12 may extend in different (e.g., opposite) directions from the first protruding rib P11.

In an embodiment, the first engagement portion P may include a second protrusion P2. The second protrusion P2 may be spaced apart from the first protrusion P1 in the width direction of the housing 510. The second protrusion P2 may protrude from the wall A3 toward the second portion A2. The second protrusion P2 may be disposed on the inner surface 510D.

In an embodiment, the second protrusion P2 may include a third protruding rib P21. The third protruding rib P21 may protrude in a longitudinal direction of the housing 510 (i.e., in a direction from the heater 550 disposed in the first portion A1 toward the battery 540 disposed in the second portion A2). The third protruding rib P21 may be substantially parallel to the first protruding rib P11.

In an embodiment, the second protrusion P2 may include a fourth protruding rib P22. The fourth protruding rib P22 may protrude from the third protruding rib P21 in a direction that intersects with (e.g., is orthogonal to) the protruding direction of the third protruding rib P21. The fourth protruding rib P22 may extend in the width direction of the housing 510. The fourth protruding rib P22 may extend in different directions from the third protruding rib P21. The fourth protruding rib P22 may be positioned on substantially the same line as the second protruding rib P12. The fourth protruding rib P22 may be spaced apart from the second protruding rib P12.

In an embodiment, the shock absorber 590 may form a stepped shape. For example, the shock absorber 590 may include a first base 591 and a second base 592. The first base 591 may be disposed on the inner surface 510D in the clearance space CS. The first base 591 may contact the wall A3. The first base 591 may contact a portion of the protective circuit board 545. The second base 592 may be disposed on the first base 591 in the clearance space CS. The second base 592 may be integrally and seamlessly connected to the first base 591. The second base 592 may contact the wall A3. The second base 592 may contact another portion of the protective circuit board 545. When viewed in a direction from the heater 550 toward the battery 540, a width of the second base 592 may be smaller than a width of the first base 591.

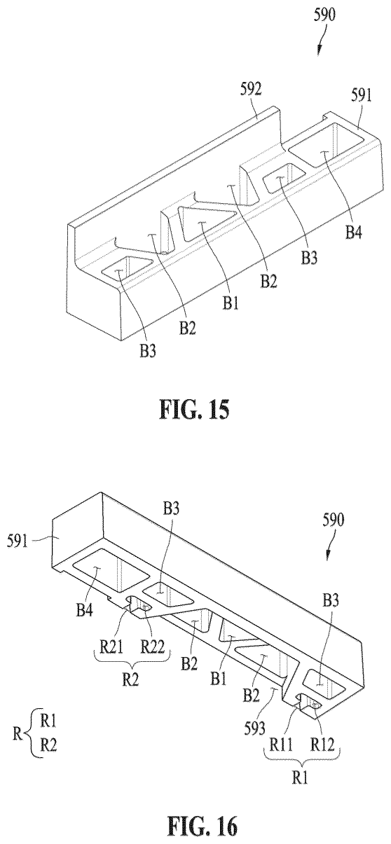

FIG. 15 is a front perspective view of a shock absorber according to an embodiment. FIG. 16 is a rear perspective view of a shock absorber according to an embodiment.

Referring to FIGS. 15 and 16, the shock absorber 590 may include the first base 591 and the second base 592.

In an embodiment, the first base 591 may include a plurality of pores (e.g., a first pore B1, a second pore B2, a third pore B3, and a fourth pore B4). The plurality of pores (e.g., the first pore B1, the second pore B2, the third pore B3, and the fourth pore B4) may pass through the first base 591. The plurality of pores (e.g., the first pore B1, the second pore B2, the third pore B3, and the fourth pore B4) may allow air to flow through the plurality of pores (e.g., the first pore B1, the second pore B2, the third pore B3, and the fourth pore B4). The plurality of pores (e.g., the first pore B1, the second pore B2, the third pore B3, and the fourth pore B4) may allow the shock absorber 590 to be gently compressed.

In an embodiment, the first base 591 may include pores of different shapes. For example, the first pore B1 and the second pore B2 may each include a pore with a substantially triangular cross-section. The third pore B3 may include a pore with a substantially trapezoidal cross-section. The fourth pore B4 may include a pore with a substantially rectangular or square cross-section.

In an embodiment, the first base 591 may include pores of substantially the same shape. For example, the first base 591 may include a plurality of second pores B2 with substantially triangular cross-sections. The first base 591 may include third pores B3 with substantially trapezoidal cross-sections.

In an embodiment, the first base 591 may include a recess 593. The recess 593 may be formed on a surface (e.g., a lower surface) of the first base 591 opposite to a surface (e.g., an upper surface) of the first base 591 on which the second base 592 is disposed. A region of the first base 591 in which the recess 593 is formed may include the first pore B1 and the plurality of second pores B2.

In an embodiment, the first base 591 may include a second engagement portion R. The second engagement portion R may be configured to engage the first engagement portion P.

In an embodiment, the second engagement portion R may include a first depression R1. The first depression R1 may be formed on the surface (e.g., the lower surface) of the first base 591 opposite to the surface (e.g., the upper surface) of the first base 591 on which the second base 592 is disposed.

In an embodiment, the first depression R1 may include a first groove R11. The first groove R11 may be configured such that the first protruding rib P11 of FIG. 13 fits into the first groove R11. The first groove R11 may extend from a side surface (e.g., a front side surface) of the first base 591 toward an opposite side surface (e.g., a rear side surface).

In an embodiment, the first depression R1 may include a second groove R12. The second groove R12 may be configured such that the second protruding rib P12 of FIG. 13 fits into the second groove R12. The second groove R12 may extend from the first groove R11 in a direction that intersects with (e.g., is orthogonal to) the extension direction of the first groove R11. The second groove R12 may extend in different directions from an end of the first groove R11.

In an embodiment, the second engagement portion R may include a second depression R2. The second depression R2 may be formed on the surface (e.g., the lower surface) of the first base 591 opposite to the surface (e.g., the upper surface) of the first base 591 on which the second base 592 is disposed. The second depression R2 may be spaced apart from the first depression R1.

In an embodiment, the second depression R2 may include a third groove R21. The third groove R21 may be configured such that the third protruding rib P21 of FIG. 13 fits into the third groove R21. The third groove R21 may extend from the side surface (e.g., the front side surface) of the first base 591 toward the opposite side surface (e.g., the rear side surface). The third groove R21 may be substantially parallel to the first groove R11.

In an embodiment, the second depression R2 may include a fourth groove R22. The fourth groove R22 may be configured such that the fourth protruding rib P22 of FIG. 13 fits into the fourth groove R22. The fourth groove R22 may extend from the third groove R21 in a direction that intersects with (e.g., is orthogonal to) the extension direction of the third groove R21. The fourth groove R22 may extend in different directions from an end of the third groove R21. The fourth groove R22 may be positioned on substantially the same line as the second groove R12. The fourth groove R22 may be spaced apart from the second groove R12.

The features and aspects of any embodiment(s) described above may be combined with features and aspects of any other embodiment(s) without resulting in apparent technical conflicts.

1. An aerosol generating device comprising:
a housing;
a heater configured to heat an aerosol generating article and disposed in a first portion of the housing;
a battery configured to supply electrical energy to the heater and disposed in a second portion of the housing;
a protective circuit board connected to the battery and disposed in the second portion of the housing such that a clearance space is formed between the protective circuit board and the second portion of the housing; and
a shock absorber configured to absorb a shock to the protective circuit board and/or the battery and disposed in the clearance space.

2. The aerosol generating device of claim 1, wherein the shock absorber is configured to reduce heat transferred from the heater to the protective circuit board and/or the battery.

3. The aerosol generating device of claim 1, wherein
the shock absorber comprises:
a first base disposed on the second portion of the housing; and
a second base disposed on the first base, and
a width of the first base is greater than a width of the second base when viewed in a direction from the heater toward the battery.

4. The aerosol generating device of claim 1, wherein the shock absorber comprises a plurality of pores.

5. The aerosol generating device of claim 4, wherein a shape of one of the plurality of pores is different from a shape of another pore.

6. The aerosol generating device of claim 4, wherein a shape of one of the plurality of pores is substantially same as a shape of another pore.

7. The aerosol generating device of claim 1, wherein
the housing further comprises at least one first engagement portion disposed in the second portion, and
the shock absorber comprises a second engagement portion configured to engage with the first engagement portion.

8. The aerosol generating device of claim 7, wherein the second engagement portion comprises a groove.

9. The aerosol generating device of claim 7, wherein the second engagement portion comprises:
a first groove extending in a first direction; and
a second groove extending in a second direction intersecting with the first direction.

10. The aerosol generating device of claim 7, wherein the first engagement portion comprises a protruding rib.

11. The aerosol generating device of claim 7, wherein the first engagement portion comprises:
a first protruding rib extending in a first direction from the heater toward the battery; and
a second protruding rib extending in a second direction intersecting with the first direction.

12. The aerosol generating device of claim 1, wherein the shock absorber is disposed to occupy substantially an entirety of the clearance space.

13. The aerosol generating device of claim 1, wherein
the housing comprises a wall configured to separate the first portion and the second portion, and
the shock absorber is disposed to contact the wall.

14. The aerosol generating device of claim 1, wherein the shock absorber comprises an elastic material.

15. The aerosol generating device of claim 1, wherein the shock absorber is configured to have a first shape in which the shock absorber is not deformed and a second shape in which the shock absorber is deformed and compressed.
